(19) United States
(12) Patent Application Publication
(10) Pub. No.: US 2022/0108325 A1
(43) Pub. Date: Apr. 7, 2022

(54) WEAR-BASED REPLACEMENT FOR ATHLETIC EQUIPMENT

(71) Applicant: Outside Interactive, Inc., Boulder, CO (US)

(72) Inventors: Ryan Trunck, Denver, CO (US); Rani K. Powers, Denver, CO (US)

(21) Appl. No.: 17/065,365

(22) Filed: Oct. 7, 2020

(51) Int. Cl. G06Q 30/00; A63B 24/00; G06Q 10/00; G06Q 10/08

(52) U.S. Cl. CPC G06Q 30/016; A63B 24/0062; G06Q 10/20; G06Q 10/083; A63B 2220/20; A63B 2220/808; A63B 2220/836; A63B 2225/20; A63B 2225/50; A63B 2230/06; A63B 2220/40; A63B 2220/17

(57) ABSTRACT

Systems and methods are provided for replacing athletic equipment. One embodiment is a system that includes a tracking server. The tracking server includes an interface that receives messaging indicating fitness histories for athletes, each of the fitness histories including records that indicate exercise activities performed by an athlete over time, and a controller that, for each of the athletes, analyzes records of exercise activities of the athlete in a corresponding fitness history, applies wear to athletic equipment for the athlete based on the records that were analyzed, and determines whether the athletic equipment exceeds a threshold level of wear. In the event that the athletic equipment exceeds the threshold level, the controller coordinates delivery of new athletic equipment to the athlete, and in the event that the athletic equipment does not exceed the threshold level, the controller foregoes delivery of the new athletic equipment to the athlete.

### FIELD

The disclosure relates to the field of athletics, and in particular, to delivery of athletic goods.

### BACKGROUND

Athletes perform at a variety of levels of competitiveness and intensity in order to achieve a variety of goals. Thus, the population of athletes runs the gamut from casual athletes who seek physical fitness, to professional athletes that work with an elite cadre of trainers and nutritionists in order to achieve a competitive edge in sporting events. The depth of knowledge of each athlete in relation to their workout regimen therefore varies widely. Furthermore, the type of equipment utilized varies widely across athletes, as does the level of knowledge regarding that equipment.

Therefore, it would be desirable to have a method and apparatus that take into account at least some of the issues discussed above, as well as other possible issues.

### SUMMARY

Embodiments described herein provide for advanced delivery networks and architectures that are capable of tracking the actions of a population of athletes on an individualized basis, and coordinating the delivery of athletic equipment, accessories, and/or nutritional supplies (hereinafter, referred to collectively as “athletic goods”) to each of the athletes based on a history of exercise activities of that athlete. Thus, instead of solely operating as a time-based subscription and fulfillment model, embodiments described herein are capable of delivering athletic goods based on an analysis of the actual fitness history of each athlete. These subscriptions may even detect an athlete reaching a new fitness threshold at which an athlete has achieved a notable increase in ability (referred to herein as a “transformation”). In response to an athlete reaching a fitness threshold, new pieces or types of athletic equipment may be provided in order to facilitate a more advanced training regimen for the athlete. Furthermore, this tracking may be performed on a massive scale in parallel for a population of thousands or millions of athletes at once, and hence the systems and methods described herein enable dynamic subscription tracking in real-time in a manner that is not possible by hand or as a mental process.

One embodiment is a system comprising a tracking server. The tracking server includes an interface that receives messaging indicating fitness histories for athletes, each of the fitness histories including records that indicate exercise activities performed by an athlete over time, and a controller that, for each of the athletes, analyzes records of exercise activities of the athlete in a corresponding fitness history, applies an amount of wear to athletic equipment for the athlete based on the records that were analyzed, and determines whether the athletic equipment exceeds a threshold level of wear. In the event that the athletic equipment exceeds the threshold level, the controller coordinates delivery of new athletic equipment to the athlete, and in the event that the athletic equipment does not exceed the threshold level, the controller foregoes delivery of the new athletic equipment to the athlete.

A further embodiment is a method. The method includes receiving messaging at an interface indicating fitness histories for athletes, each of the fitness histories including records that indicate exercise activities performed by an athlete over time, and for each of the users: analyzing records of exercise activities of the athlete in a corresponding fitness history, applying an amount of wear to athletic equipment for the athlete based on the records that were analyzed, determining whether the athletic equipment exceeds a threshold level of wear, in the event that the athletic equipment exceeds the threshold level, coordinating delivery of new athletic equipment to the athlete, and in the event that the athletic equipment does not exceed the threshold level, foregoing delivery of the new athletic equipment to the athlete.

A further embodiment is a non-transitory computer readable medium embodying programmed instructions which, when executed by a processor, are operable for performing a method. The method includes receiving messaging at an interface indicating fitness histories for athletes, each of the fitness histories including records that indicate exercise activities performed by an athlete over time, and for each of the users: analyzing records of exercise activities of the athlete in a corresponding fitness history, applying an amount of wear to athletic equipment for the athlete based on the records that were analyzed, determining whether the athletic equipment exceeds a threshold level of wear, in the event that the athletic equipment exceeds the threshold level, coordinating delivery of new athletic equipment to the athlete, and in the event that the athletic equipment does not exceed the threshold level, foregoing delivery of the new athletic equipment to the athlete.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 depicts a delivery network for athletic goods in an illustrative embodiment.

FIG. 2 describes input sources that provide metrics to a tracking server in an illustrative embodiment.

FIG. 3 is a block diagram of a normalization server that transforms incoming messaging into a uniform format in an illustrative embodiment.

FIG. 4 is a block diagram depicting a flow of messaging to and from a tracking server in an illustrative embodiment.

FIGS. 5-6 depict profiles of athletes stored at a tracking server in an illustrative embodiment.

FIGS. 7-8 depict records that describe exercise activities in an illustrative embodiment.

FIGS. 9-11 depict equipment profiles for athletic equipment in an illustrative embodiment.

FIG. 12 is a message diagram depicting communications between components of a delivery architecture in order to provide dynamic wear-based replacement of athletic equipment in an illustrative embodiment.

FIG. 13 is a flowchart illustrating a method for providing activity-based subscriptions in an illustrative embodiment.

FIG. 14 is a flowchart illustrating additional details of the method of FIG. 13 in an illustrative embodiment.

FIG. 15 is a flowchart illustrating additional details of the method of FIG. 13 in an illustrative embodiment.

FIG. 16 depicts a computing system operable to execute programmed instructions embodied on a computer readable medium in an illustrative embodiment.

### DESCRIPTION

The figures and the following description provide specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

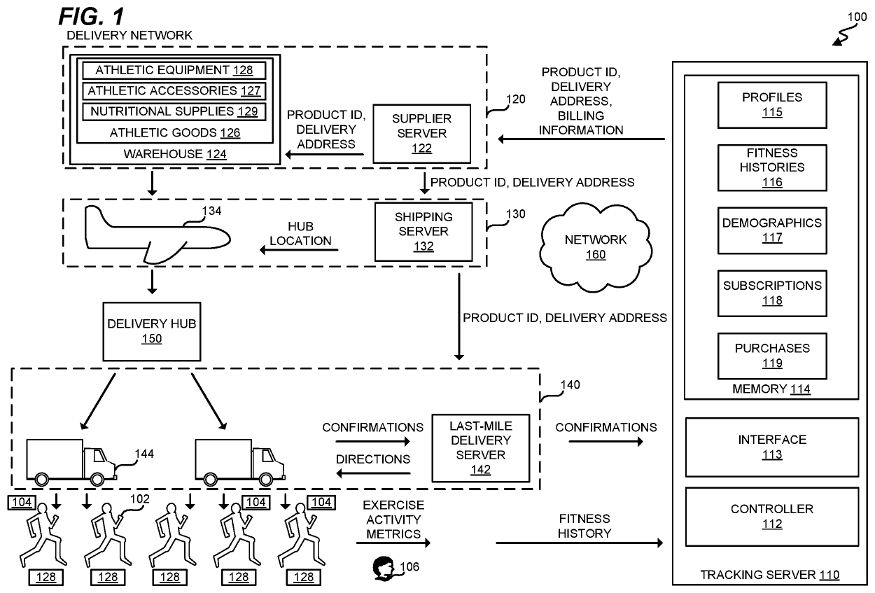

FIG. 1 depicts a delivery network 100 for athletic goods 126 in an illustrative embodiment. Specifically, delivery network 100 comprises any combination of systems, devices, or components that are operable to coordinate the delivery of athletic goods 126 to athletes 102. Examples of athletic goods 126 include athletic equipment 128 (e.g., kettlebells, bicycles, tires, shoes, gloves, volleyballs, yoga mats, etc.), athletic accessories 127 (e.g., fitness trackers, journals, workout plans, books, magazines, etc.), and nutritional supplies 129 (e.g., energy bars, gel blocks, sports drinks, bulk protein, entire meals, etc.). As used herein, athletic equipment 128 for an athlete 102 comprises tangible, non-food items that are utilized during an exercise activity to facilitate performance of the exercise activity, including clothing worn during an exercise activity. Athletic equipment 128 further includes specialized pieces of gear (or components thereof) that are necessary in order to perform an exercise activity. For example, athletic equipment 128 may include bicycles (including tires, shifters, gear sets, brakes, and other components thereof), snowboards, skis, tennis racquets, volleyballs, etc.

In this embodiment, delivery network 100 comprises a unique arrangement of devices and components that together analyze fitness histories 116 of athletes 102, determine an amount of wear applied to athletic equipment 128 owned by those athletes 102, and coordinate delivery of athletic goods 126 (e.g., replacement athletic equipment 128, athletic accessories 127, nutritional supplies 129) to those athletes 102 based on wear applied to the athletic equipment 128. As used herein, athletes 102 include individuals that utilize athletic equipment 128 to exercise or compete on a regular or periodic basis.

In the embodiment of FIG. 1, users 106 of the delivery network 100, and/or fitness trackers 104 (e.g., smart watches or wristbands that are worn by, accompany, or otherwise track the athlete 102 during exercise activities) generate metrics that describe exercise activities performed by a corresponding athlete 102, and provide those metrics to a tracking server 110 over time on ongoing or periodic basis. Users 106 may provide the metrics via tablets, cellular phones, laptop computers, etc. In one embodiment, each athlete 102 is also a user 106 for their own account stored at tracking server 110. However, in some instances the users 106 include support personnel (e.g., coaches, trainers, physical therapists, nutritionists, etc.) for an athlete 102. Thus, the term “user” is not necessarily synonymous with the term “athlete” as used herein. In many embodiments, for each user 106, there is a single associated athlete 102. However, in further embodiments, a user 106 represents an organization such as a gym, team, or club that includes multiple athletes 102. In such instances, the organization may own, maintain, or operate many nutritional supplies 129, athletic equipment 128, and athletic accessories 127 on behalf of the athletes 102 in the organization.

The exercise activities performed by athletes 102 over time are reported to tracking server 110 for analysis, and are accompanied by metrics that describe the nature of the exercise activity that was performed. As used herein, an exercise activity comprises an event, action, or series of actions during which aerobic or anaerobic exercise occurs for the athlete 102, and may include a run, a race, a bicycle ride, a lifting routine, a dance practice, swimming at a pool, etc. In one embodiment, exercise activities include at least one piece of information selected from the group consisting of: scheduled events listed on a calendar, a workout history, reported event attendance for an athlete, a dietary log of the athlete, and a wellness log of the athlete. In a further embodiment, exercise activities include at least one piece of raw data selected from the group consisting of: sleep tracking data, step tracking data, heart rate data, elevation data, accelerometer data, pulse data, and audio data.

Exercise activities for organizational users may indicate events that are hosted by the organization and are attended by multiple athletes. Metrics for an exercise activity of an organizational user may therefore describe an activity performed by multiple athletes at the same time (e.g., an exercise class or group race hosted by the organization, etc.). The start or end of an exercise activity may be indicated based on manual input (e.g., a button press for a fitness tracker 104), may be determined dynamically based on accelerometer information (e.g., indicating that a run or ride is presently occurring), may be determined based on information in a calendar, or based on information from any other suitable source. In one embodiment, fitness histories, and the exercise activities which they report, are dynamically determined by wearable devices (e.g., fitness trackers 104) or mobile devices of the athletes 102, based on such information.

Metrics are provided to tracking server 110 to describe exercise activities performed by athletes 102, and these metrics can be manually generated by users 106 based on typed or templated input (e.g., fillable forms), and/or can be automatically generated by fitness trackers 104 during exercise activities. Each exercise activity may be described using a variety of different metrics, and these metrics range from raw measurements (e.g., raw accelerometer data, raw audio data, raw glucose data over from a continuous glucose sensor, raw data from a Global Positioning System (GPS)) to processed statistics (e.g., number of steps taken based on an analysis of raw accelerometer data, speed based on GPS data over time, etc.). Depending on embodiment and the capabilities of a fitness tracker 104 used by the athlete 102, processed statistics may be generated at the fitness tracker 104 and provided to the tracking server 110, or a controller 112 of the tracking server 110 may process raw measurements in order to generated desired processed statistics.

In order to facilitate the generation and processing of metrics for an exercise activity, an exercise activity is assigned a category. A category indicates the type of exercise being performed. For example, a category may indicate that an exercise activity relates to cycling, skiing, running, swimming, or other type of exercise. Each possible category is associated with one or more types of athletic equipment 128, such that a category for cycling may be associated with types such as bicycles, helmets, gloves, and tires, while a category for swimming may be associated with types such as goggles, flippers, and wet suits. The category of exercise activity may be identified in a variety of ways. In one embodiment, the source that provided metrics for the exercise activity is used as an indicator for the type of activity. For example, metrics from a GPS device provided via a “ski tracking” mode can be assigned to the skiing or snowsports category. In further embodiments, the type of activity is determined based on manual input, input provided via a form or app by the user 106, or based on an analysis of metrics provided for the exercise activity. For example, accelerometer data exhibits different patterns of motion when running than while cycling, and hence accelerometer data can be analyzed to categorize an exercise activity as either running or cycling. In further embodiments, an activity is categorized based on a location where the activity took place (e.g., at a specific type of gym or park), or on an event indicated in a calendar for the athlete 102. Exercise activities may be further manually categorized by the user 106, categorized based on rules defined by a user 106, categorized by a fitness tracker 104, or categorized by a tracking server 110 that acquires metrics therefrom.

Still further types of data, and/or combinations thereof, such as GPS data, map data, satellite imagery other remotely sensed imagery, gyroscopic data and/or accelerometer data, and/or United States Geological Survey (USGS) Earth Resources Observation and Science (EROS) data, may be considered when detecting and documenting exercise activities at controller 112 or a fitness tracker 104. For example, map data that is missing for a period of time may be backfilled with GPS data or USGS EROS data to determine amounts of elevation change or distance traveled. In a further example, additional types of data may include additional contextual information describing an activity. For example, if a running activity is performed along a trail, and remotely sensed imagery for the day indicates that the trail is bright white (i.e., has a greater than threshold albedo), and weather information indicates that the temperature is below a threshold (e.g., forty degrees), the remotely sensed imagery may be utilized to infer the presence of snow. In yet another example, a combination of the data types above may be considered in combination to determine a type of activity, and/or the equipment being used for the activity. In this manner, speed, elevation change, and/or terrain type may influence a determination made by controller 112 (or a fitness tracker 104) of whether or not a bicycle is being used, as well as what type of bicycle is being used (e.g., a mountain bike versus a road bike).

In one embodiment, multiple tiers of categories are implemented at different levels of granularity. For example, a category for “cyclocross race” be associated with much more narrow types of athletic equipment (e.g., competition cyclocross bicycle) than the category of “cycling” (e.g., any bicycle), even though the category of “cyclocross race” is a sub-category of the “cycling” category.

Exercise activities may further be assigned metrics indicating a date, time, and/or duration of the activity, a location or set of locations at which the activity occurred, a total distance traveled, a total elevation change (upward and/or downward), an average pulse rate, an intensity of activity, etc. Furthermore, each of these metrics may be provided as an average or total for the activity, or as a running count or amount aggregated over a period of time. For example, step tracking information for an exercise activity may indicate the total number of steps traveled, and/or the time that each step was taken.

Metrics for exercise activities may further indicate a latitude and/or longitude, in the form of a start and/or finish position, and/or as a series of locational coordinates provided over time. In further embodiments, data for exercise activities includes one or more images acquired during the exercise activity. By analyzing these images for certain color tones or patterns (e.g., via operation of a trained neural network), a controller at the fitness tracker 104 or at the tracking server 110 may assign a terrain type to the exercise activity. Alternatively, terrain type may be explicitly indicated for an exercise activity, or may be inferred based on locations of the athlete 102 during the exercise activity, wherein each of multiple locations is categorized to include one or more terrain types. In still further embodiments, a terrain type, category of exercise activity, breathing rate, and/or other metrics are determined based on sound input acquired during the exercise activity by the fitness tracker 104. For example, sound input where a user repeatedly counts to a number may indicate interval training, Tabata training, or a lifting routine, while the sound of repeated footfalls or turning pedals may be analyzed to detect a running or cycling activity.

In a further embodiment, metrics indicating ascent and descent, such as accelerometer measurements over time, or location data (e.g., GPS data including elevation data) over time is utilized to determine terrain characteristics and/or impact force for steps when running. For example, if a percentage of footfalls (e.g., half of footfalls) or number of footfalls in a row (e.g., fifty footfalls) during a run exhibit a threshold difference in height (e.g., of six inches or more, three inches or more, etc., or a corresponding amount of acceleration) from the prior step, then the terrain may be determined to be rough. This may particularly be the case when the net elevation change across the entire exercise activity is less than a threshold amount (e.g., only a few feet or few tens of feet). In addition to reporting metrics for an exercise activity, in one embodiment a fitness tracker 104 includes functionality for providing notifications to an athlete 102. In such an embodiment, a fitness tracker 104 may acquire information from a third party server, such as a weather service accessible via an Application Programming Interface (API), prior to a scheduled or anticipated athletic event. If the weather information indicates inclement weather in the form of precipitation or excessive heat, the fitness tracker 104 generates a notification for the athlete 102. For example, if weather data indicates temperatures above a threshold level at one or more locations where the exercise activity is going to take place, the fitness tracker 104 may update its display to indicate a need to pack water, or may send such a notification via SMS to the user 106 or athlete 102. Alternatively, if the fitness tracker 104 detects current or expected precipitation during the exercise activity, it may update its display or send an SMS message indicating a need to pack a rain coat or umbrella.

Third party data may also be utilized to validate and/or verify conclusions regarding the type of exercise activity being performed and/or equipment being used. For example, third party data in the form of photographs of an athlete at an event may be analyzed via machine learning techniques (e.g., neural networks, generative adversarial networks, etc.) in order to detect the presence of a specific athlete (e.g., based on a bib number or ID card worn by the athlete as shown in a photograph). The athletic equipment used by that athlete (e.g., shoes, skis, bicycles, etc.) during the exercise activity may then be detected via image analysis, by comparing image data in the photograph with expected image data for the equipment (e.g. via a trained machine learning technique). The system may then determine, in response to verifying that the equipment was present at the event, that a profile for the equipment has been updated to reflect the wear applied during the exercise activity. Third party data in the form of photographs may also be utilized to determine the prevalence of different types of equipment at an athletic event. This information may then be sold or otherwise provided to manufacturers of equipment to indicate the popularity of different types of equipment.

In further embodiments, notifications may indicate a need for packing nutritional supplies (e.g., energy gel, nutritional bars, electrolyte supplements, etc.) based on weather data, based on an expected intensity of an exercise activities, or based on a category for an exercise activity. For example, certain categories of activities (e.g., races, challenges, invitationals, marathons, triathlons, etc.) may be associated with the need for certain supplies, accessories, equipment, or notifications.

In one embodiment, a fitness tracker 104 predicts a time at which an athlete 102 will arrive at the finish location of an exercise activity based on current pace data, and predicts weather at the finish location at the predicted time. In yet another embodiment, the fitness tracker 104 predicts conditions that will be encountered along a planned route of an exercise activity, such as a cycling trip, and provides dynamic notifications to warn of inclement weather, accidents, and/or road or trail closures. In further embodiments where an athlete has been registered for an event, a data source such as an email, participant registry, or other data source may be reviewed to detect the registration. If anticipated conditions for the event change from an expected level (e.g., based on expected changes in temperature and/or precipitation with respect to prior anticipated conditions), then new equipment suitable for the change in anticipated conditions are provided. For example, if an outdoor running event changes from expected dry weather to expected rain, shoes may be provided with deeper treads, a waterproof layer of clothing may be provided, etc.

The various metrics discussed above for exercise activities are provided to tracking server 110 on an ongoing or periodic basis and are used by controller 112 to build a fitness history 116 for each of the athletes 102. As used herein, a fitness history 116 comprises a collection of records that indicate exercise activities performed by an athlete 102 over time. In one embodiment, each record describes a specific exercise activity performed by an athlete 102.

The fitness histories 116 are provided to tracking server 110 and/or generated by a controller 112 of the tracking server 110 after analyzing messaging (received via network 160, such as the Internet, a private network, a cellular network, etc.) that describes exercise activities. Upon receiving messaging indicating the fitness histories 116 at interface 113 (e.g., an Ethernet interface, wireless interface, etc.), the controller 112 of the tracking server 110 stores fitness histories 116 in memory 114.

In addition to fitness histories 116, tracking server 110 also stores profiles 115 for the athletes 102 in memory 114. These profiles 115 may be maintained and updated by users 106 over time. The profiles 115 recite billing information and a delivery address pertaining to the athlete 102 (e.g., billing information for charging the athlete, or an associated sponsor or organization), and also recite the athletic goods (including athletic equipment) owned and/or operated by the athlete 102. Thus, by reviewing a profile 115 for an athlete 102, the controller is capable of determining what athletic equipment is currently owned or operated by that athlete 102. The controller 112 may also receive indication of purchases 119 made by or on behalf of the athlete 102 over time from the fitness trackers 104 or via third party sources (e.g., directly from distributors of the athletic equipment, via cookies on Internet browsers, etc.). Subscriptions 118 stored in memory 114 each indicate what athletic equipment of an athlete 102 is subject to a subscription for wear-based replacement. Controller 112 may also utilize demographics 117 for each athlete 102 to determine whether each athlete 102 prefers certain types of athletic equipment 128, athletic accessories 127, and/or nutritional supplies 129.

On a periodic (e.g., hourly, daily, monthly, weekly, bi-weekly, monthly, yearly) or ongoing basis, the controller 112 analyzes records of the exercise activities of each athlete in a corresponding fitness history 116 stored in memory 114. By reviewing information describing each of the exercise activities in the fitness history 116 of an athlete 102, the controller 112 is able to determine an amount of wear applied to each athletic equipment 128 owned or used by the athlete 102.

After determining that an athletic equipment 128 has reached more than a threshold amount of wear, the tracking server 110 coordinates the delivery of new athletic equipment 128 to an athlete 102. The coordination process involves transmitting messaging via interface 113 and network 160 to contact a supplier server 122 of a supplier 120 of the new athletic equipment 128 (e.g., an owner of a warehouse storing the new piece of athletic equipment, such as Amazon.com, Inc.). The messaging includes an identifier for the new athletic equipment, as well as a delivery address for the athlete 102.

The supplier 120 provides the new athletic equipment 128 from a warehouse 124 to a shipping entity 130. In many instances, the shipping entity 130 comprises a company that is dedicated to transportation of goods, and that performs shipping on a massive scale (e.g., Federal Express Corp.) from warehouses to delivery hubs. The shipping entity 130 is contacted via messaging from the supplier server 122 to the shipping server 132, and utilizes shipping vehicles 134 (e.g., airplanes, trains, ships, trucks, vans, bicycles, drones, etc.) to transport the new athletic equipment 128 to a delivery hub 150 that is located close to (e.g., within fifty miles of) a delivery address of the user. New athletic equipment 128 at the deliver hub 150 is delivered via a last mile delivery service 140. In some embodiments, the last mile delivery service 140 and the shipping entity 130 comprise the same entity. The last mile delivery service 140 utilizes vehicles 144 to provide the new athletic equipment 128 to the athlete 102, based on messaging transmitted from shipping server 132 to last-mile delivery server 142.

Upon successful delivery, the last-mile delivery server 142, shipping server 132, and/or supplier server 122 provide a confirmation to the tracking server 110, the athlete 102, and/or the user 106 that delivery has been completed. Controller 112 detects messaging via the interface 113 confirming successful delivery of the new equipment to the athlete 102. Next, the controller 112 of the tracking server 110 updates the profile 115 of the athlete 102 to add the new athletic equipment 128, such as by replacing the old athletic equipment 128.

In some embodiments, the controller 112 determines an amount of use of the athletic equipment 128 rather than amount of wear, or determines an amount of activity performed by the athlete 102 over time based on the fitness history 116 of that athlete. In such embodiments, a fitness history may indicate a number of miles traveled, number of calories consumed, or other information which may be utilized as a basis for delivering athletic accessories 127 and/or nutritional supplies 129. For example, if a threshold number of traveled miles, attended activities, of consumed calories reaches a threshold, additional nutritional supplies 129 may be delivered in a similar manner to the delivery of athletic equipment discussed above.

The various servers described with regard to FIG. 1 may comprise a single physical computer or cluster of computers. Any of the various servers and electronic devices discussed herein may include one or more controllers and memories similar to those described for tracking server 110. In one embodiment, controller 112 (and/or any other of the controllers discussed herein) is implemented as custom circuitry, as a hardware processor executing programmed instructions stored in memory, or some combination thereof. Memory 114 (and/or any other of the memories discussed herein) is implemented as a computer readable medium such as a flash memory, hard disk, Random Access Memory (RAM), optical media, or other electronic storage device.

All of the operations discussed above may be performed by tracking server 110 on a periodic or ongoing basis for millions of athletes 102, each athlete 102 having tens or hundreds of instances of athletic equipment 128 subject to wear-based subscription plans. This results in the tracking server 110 receiving tens of millions of updates on an hourly basis. The scope and scale of these operations mean that they simply cannot be performed by hand or as a mental process. This insight regarding real-time wear tracking is true even when the population of athletes comprises hundreds or thousands of individuals.

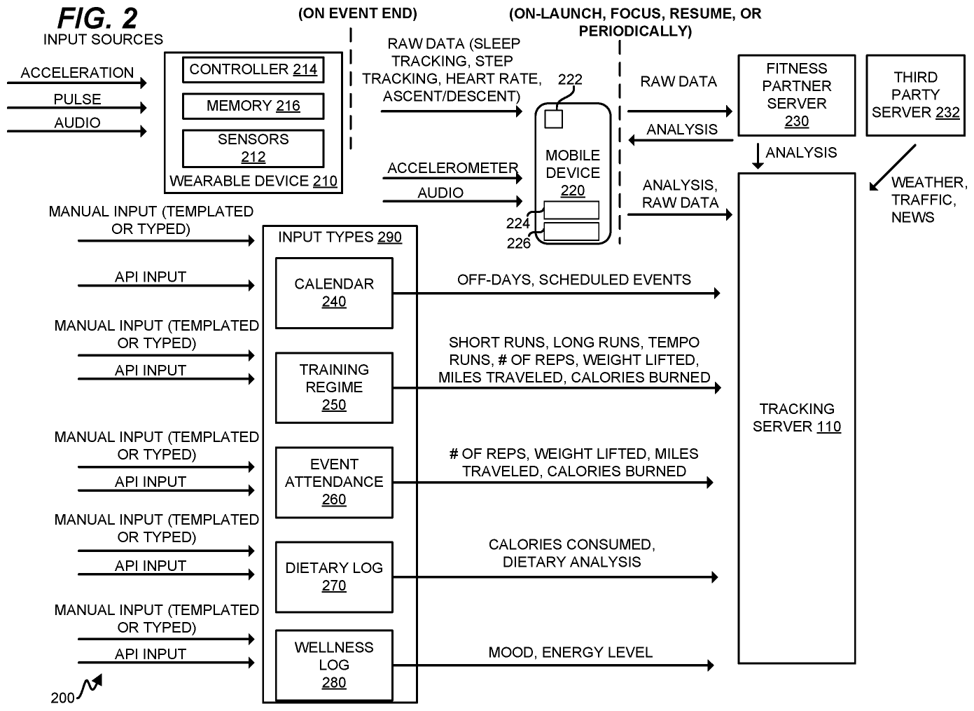

With the architecture of FIG. 1 fully described above, FIG. 2 describes input sources 200 that provide metrics to a tracking server 110. Such input sources may comprise fitness trackers 104, other athletic accessories for an athlete 102, or computing devices operated by a user 106.

In this embodiment, input sources 200 includes a wearable device 210 (e.g., a fitness tracker 104 such as a smart watch or band), which records measurements for an athlete 102 in real-time during an exercise activity. While only one wearable device 210 is depicted, in practice millions of athletes 102 may utilize millions of wearable devices 210 to record and report metrics to a tracking server 110. These metrics may include acceleration data, pulse data, audio information, and other content. The wearable device 210 includes sensors 212 (e.g., accelerometers, microphones, pulse oximeters, a glucose monitor, a camera, etc.), a controller 214, and a memory 216. In one embodiment, controller 214 analyzes input from the sensors 212 to generate new metrics that describe the exercise activity. For example, controller 214 may analyze raw pulse oximetry readings to determine a pulse rate, may track acceleration to determine pedometry metrics (e.g., steps taken) or total distance traveled, may review audio data to determine breathing rate and depth, etc. Metrics from wearable device 210 may be provided directly to tracking server 110 via network 160, or may be provided to an intermediary mobile device 220 or home computer for processing and provisioning to the tracking server 110.

Mobile device 220 (e.g., a cellular phone, tablet, etc.) includes an antenna 222 that is adapted to communicate with a cellular network, and further includes a controller 224 and memory 226. In one embodiment, mobile device 220 acquires metrics from a wearable device 210, and processes the metrics to generate a fitness history that includes a series of exercise activities. In a further embodiment, controller 224 acquires measurements (e.g., raw sensor data) from the wearable device 210 and/or sensors at the mobile device 220, and processes the measurements to generate metrics in a similar manner to the controller 214 of wearable device 210. These metrics are stored in memory 226. In further embodiments the mobile device 220 forwards raw or formatted data onward to a fitness partner server 230, such as a server operated by a provider of a fitness, wellness, or dietary application stored on the mobile device 220. The fitness partner server 230 further analyzes the metrics to further characterize exercise activities performed by the athlete 102.

The wearable device 210, mobile device 220, and/or fitness partner server 230 provide metrics to tracking server 110, and all of these metrics, from raw measurements to the processed statistics, together form the basis of a fitness history 116 for an athlete 102. In some embodiments, the metrics provided to the tracking server 110 explicitly recite each exercise activity included the fitness history 116, while in further embodiments, the tracking server 110 utilizes controller 112 to determine the nature of exercise activities in a athlete's fitness history 116 (e.g., by analyzing the metrics or other data associated with the exercise activity)). The fitness history 116 may also include a variety of pieces of information gleaned from manual input, templated typed input (e.g., fillable forms generated for a user), or Application Programming Interface (API) data received at the tracking server 110.

Tracking server 110 may also acquire data from a third party server 232 (e.g., a server operated by a news agency, traffic department, weather agency, etc.) indicating, for example, weather information, traffic information, or news information pertaining to the time and/or location at which exercise activities occur. Controller 112 utilizes this information to apply tags or other descriptors to the exercise activity. For example, if an athlete 102 participates in a distance run on July seventh, and a rainstorm occurred at the location of the run on that date, then the controller 112 of the tracking server 110 may determine that the exercise activity occurred in the rain. This information may impact the amount of wear expected to be caused by the exercise activity.

FIG. 2 also illustrates a variety of input types 290 that provide information for a fitness history 116. In this embodiment, the input types 290 provided for an athlete 102 include events listed on a calendar 240 stored in memory. These events may indicate off-days, scheduled activities, and other information. In one embodiment, the type of exercise activity performed, distance traveled, and/or duration of exercise activity is inferred from events in a calendar 240 based on a title of each event and a duration of each event. For example, a “speed run 5k” event on a calendar 240 may be categorized by controller 112 as a distance running event covering five kilometers of distance.

Input types 290 further include training regime 250. Training regime 250 may comprise a work out journal indicating the results of prior exercise activities, or a predefined work out schedule indicating the nature of future planned activities. In one embodiment, the training regime includes entries indicating a duration or distance of running activities, a number of repetitions (“reps”) of various lifting and/or aerobic activities, and/or a number of calories burned for each exercise activity.

Input types 290 further include a history of event attendance 260. Event attendance 260, for example as indicated by registration records for participation in a race, is analyzed to determine that an athlete 102 has participated or will participate in an event. Parameters determined for the event indicated in the registration records (e.g., a distance, type of exercise activity, or other information) can also be added to the fitness history of a corresponding athlete 102.

Input types 290 also include a dietary log 270 and a wellness log 280. The dietary log 270 includes information indicating calories consumed, types of food eaten, times that food was eaten, and/or similar information. Calories consumed, in combination with weight measurements for an athlete 102, can be utilized by controller 112 to infer an intensity of exercise activities. For example, if an athlete 102 is eating five to ten thousand calories per day and not gaining weight, controller 112 may infer that the activities for the athlete 102 are high-intensity activities.

Wellness log 280 may include entries indicating the physical and/or emotional wellness of an athlete 102, such as a mood and/or energy level of an athlete 102. These entries may be reviewed to determine whether an athlete 102 is experiencing issues related to their current athletic equipment. By analyzing a type of injury or pain (e.g., an anatomical location of pain, or descriptor of pain sensation) suffered by athlete 102 and reported in wellness log 280, controller 112 may determine that an athletic equipment has reached the end of its usable lifetime. For example, if an athlete 102 is complaining of shin splints, controller 112 may determine that the sole of the current shoe of the athlete 102 is worn out and hence the shoe is in need of replacement. In a similar fashion, if a cyclist reports that they are feeling groin or back pain, then a new seat or new shocks may be desirable for their bicycle.

The various input types 290 discussed above may be provided in any suitable message format, and may be provided via text messaging or internet traffic according to a variety of specific file formats and standards. The massive amount and variety of information provided to the tracking server 110 may be difficult for a controller 112 to categorize and process if it is provided in a variety of non-uniform formats. Thus, normalization may be utilized to ensure that messaging is consistently formatted when it is provided to a tracking server 110.

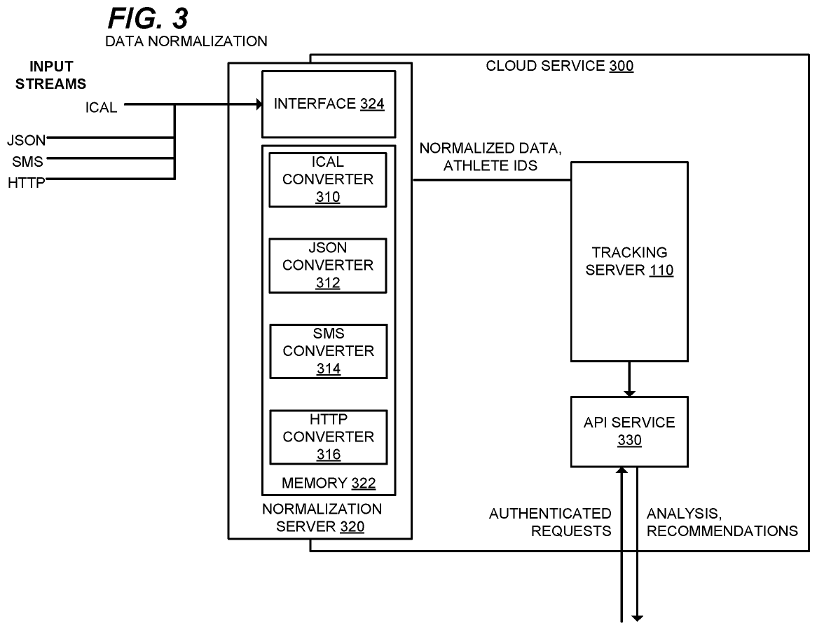

FIG. 3 is a block diagram of a cloud service 300 that utilizes a normalization server 320 to transform incoming messaging into a uniform format in an illustrative embodiment. In this embodiment, normalization server 320 reformats data provided in iCalendar (ICAL), JavaScript Object Notation (JSON), Short Messaging Service (SMS), and/or HyperText Transfer Protocol (HTTP) formats, prior to providing the normalized data to a tracking server 110. For example, in one embodiment, a memory 322 of a normalization server 320 includes instructions for converting ICAL data (ICAL converter 310), instructions for converting JSON (JSON converter 312), instructions for converting SMS (SMS converter 314), and instructions for converting HTTP (HTTP converter 316) into a series of standardized records describing exercise activities over time on an activity by activity basis. The instructions for converting each type of input may be performed by identifying tags within the received data, and populating fields of a record for an exercise activity (e.g., title, category, corresponding athlete, etc.) based on those tags.

Normalization server 320 receives non-normalized data at an interface 324 (e.g., an Ethernet or wireless interface), and operates the interface 324 to provide normalized data to a tracking server 110 (e.g., via a network). In this embodiment, tracking server 110 directly handles requests that have already been normalized via an API service 330 supported by the tracking server 110, and provides analysis and recommendations via the API. Because the API service 330 formats received data in an expected format to tracking server 110, normalization of API data is unnecessary.

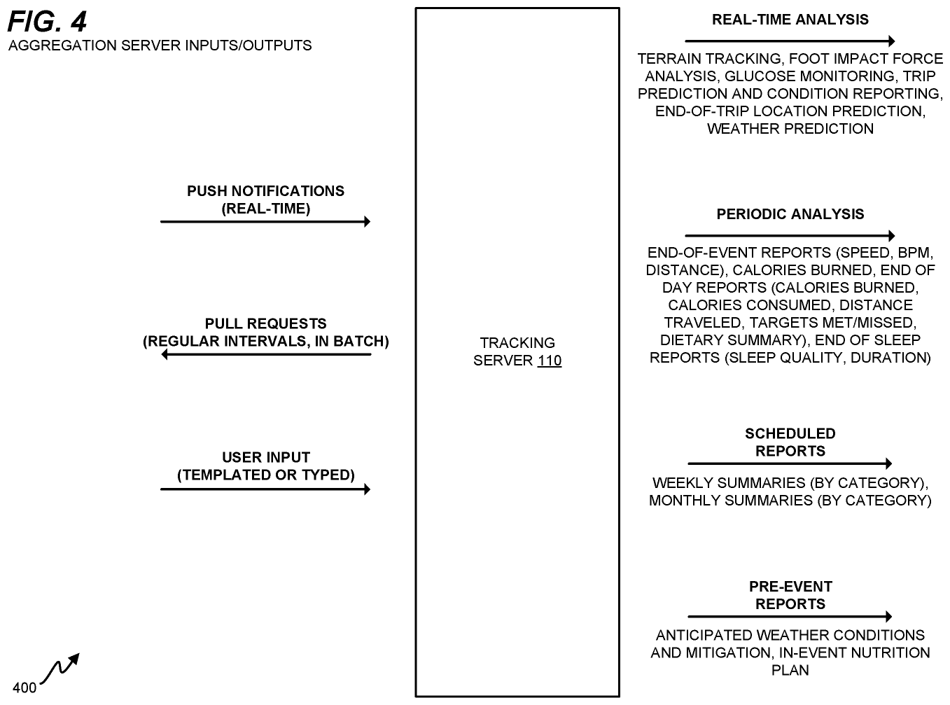

FIG. 4 is a block diagram 400 depicting a flow of messaging to and from a tracking server 110 in an illustrative embodiment. In this embodiment, data provided to a tracking server 110 comes in the form of push notifications received in real-time, as well as user input provided periodically from users 106 via templated or typed input formats. The tracking server 110 also periodically pulls information pertaining to the fitness histories 116 of athletes 102 on a periodic basis. These inputs may be acquired from fitness partner servers, mobile devices, fitness trackers, etc. A fitness partner comprises an entity that tracks exercise activity data for an athlete on an independent basis. Based on received input, the tracking server 110 may generate real-time analyses of data, periodic analyses of data, and/or scheduled reports for users 106 and/or athletes 102. Examples of such analyses are included in FIG. 4.

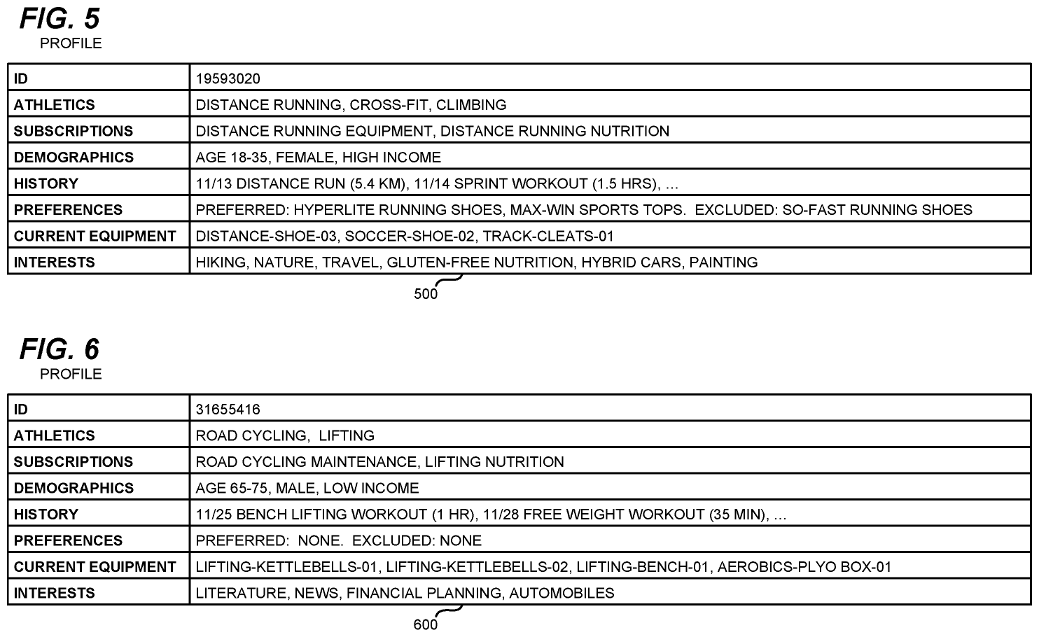

FIGS. 5-6 depict profiles 500 and 600 of athletes, and are stored at a tracking server 110 in an illustrative embodiment. Profiles 500 and 600, which are examples of profiles 115, are utilized at the tracking server 110 to determine the types of exercise activities that an athlete 102 participates in, the subscriptions that an athlete 102 has purchased, the demographics of the athlete 102, a fitness history of the athlete 102 (e.g., in the form of links or references to records of exercise activities), preferences of the athlete 102 pertaining to athletic equipment, current athletic equipment owned or operated by the athlete 102 (e.g., in the form of links or references to equipment profiles), and interests of the athlete 102. Each profile is also associated with an identifier (ID) that uniquely distinguishes the athlete 102 or user 106 from other athletes 102 or users 106. For example, profile 500 indicates that an athlete 102 engages in distance running, cross-fit, and climbing activities, while profile 600 indicates that a different athlete 102 engages in road cycling and lifting. Based on this information, tracking server 110 may categorize records for incoming exercise activities for these athletes 102 into categories of distance running, cross-fit, and climbing for the first athlete 102, and road cycling and lifting for the second athlete 102. That is, if the category of an exercise activity reported in a fitness history is uncertain, controller 112 may select from a limited number of exercise activities performed by the athlete 102 (instead of all possible exercise activities). The demographics of an athlete 102 may be utilized to help determine the intensity of an exercise activity. For example, one heart rate may indicate moderate activity for a younger person, but may indicate high intensity activity for an older person.

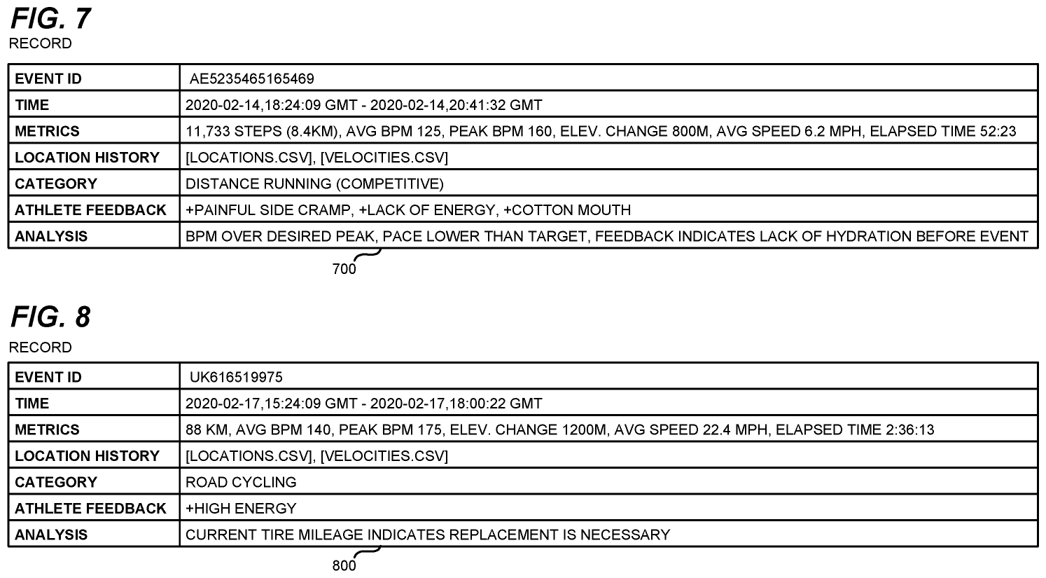

FIGS. 7-8 depict record 700 and record 800 that describe exercise activities in an illustrative embodiment. Each exercise activity corresponds with one or more specific athletes 102. Furthermore, each exercise activity is indicated by an event ID that is either unique across all athletes 102 or users 106, or unique to the athlete 102 that the exercise activity relates to. The records 700 and 800 also indicate a time or range of time during which the exercise activity took place, metrics for the exercise activity (i.e., measurements and corresponding analysis acquired during the exercise activity and/or pertaining to the exercise activity), and a location history for the exercise activity. The record for an exercise activity also categorizes the exercise activity. Each category is associated with one or more types of athletic equipment. For example, road cycling may be associated with athletic equipment in the form of road bicycles (and associated components), as well as road cycling helmets, shoes, and gloves, while weight lifting may be associated with a practice mat and specific types of weights. If an athlete 102 owns or operates athletic equipment that is associated with the category of exercise activity, then controller 112 may apply wear to the athletic equipment based on the metrics recorded for the exercise activity.

In this embodiment, the records 700 and 800 also indicate athletic feedback from an athlete 102 after an activity, and an analysis of the metrics for the activity. In one embodiment, the analysis includes suggestions indicating how an exercise activity may be performed more effectively in the future (e.g., by stating “lack of hydration before event” to indicate that more hydration is needed prior to future events), or suggestions indicating that it is time to replace certain pieces of athletic equipment. This analysis may be performed via a natural language analysis or keyword search of athlete feedback. For example, a condition of dehydration during an event may be determined by detecting keywords such as “thirsty,” “dry,” and “dehydrated” as recited in a predefined list in memory 114.

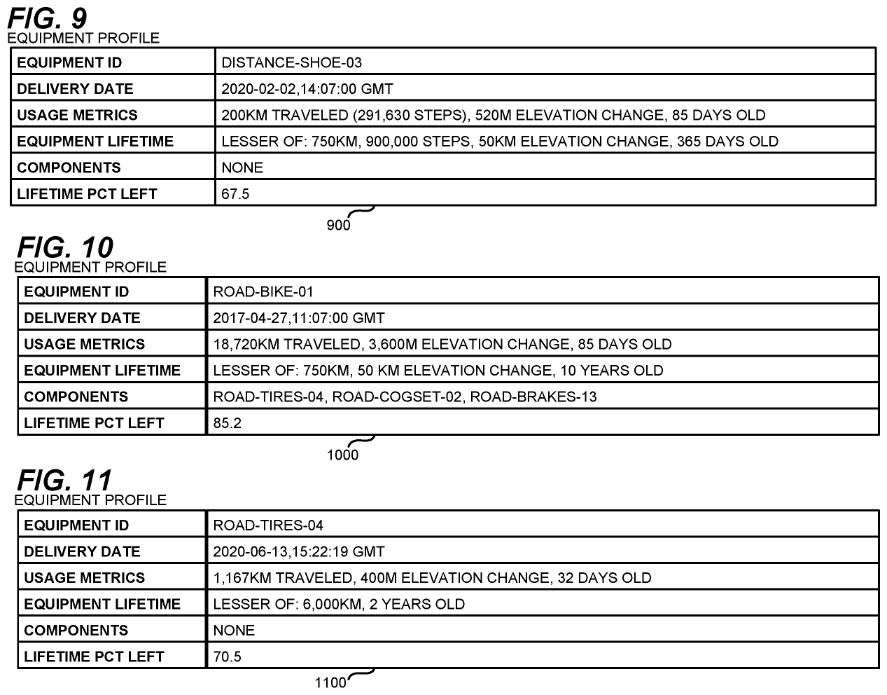

FIGS. 9-11 depict equipment profiles for athletic equipment in an illustrative embodiment. The purpose of an equipment profile is to indicate the current status of each athletic equipment owned or operated by an athlete 102. Thus, each equipment profile is associated with an athlete 102 or user 106 indicated in a profile 115. In this embodiment, equipment profile 900 describes a distance running shoe, equipment profile 1000 describes a road bicycle, and equipment profile 1100 describes a set of road tires. Each athletic equipment is described in an equipment profile with a unique identifier, and each equipment profile also any components of corresponding athletic equipment, and an estimated percentage of lifetime left for that athletic equipment. The type of athletic equipment (e.g., bicycle, shoe, ski, cyclocross helmet) may be indicated in the unique identifier, or may be separately listed in the equipment profile. The type of athletic equipment may be utilized by controller 112 to determine exercise activities that are applicable to the athletic equipment.

An equipment profile may indicate a variety of different types of lifetime metrics for a piece of equipment, including wear metrics (indicating amounts of use/wear applied to athletic equipment), and time-of-ownership metrics (indicating time that the athletic equipment has been owned). Wear metrics indicate usage of athletic equipment in a manner that applies wear to the athletic equipment. For example, wear metrics for a shoe may indicate distance traveled, steps taken, elevation change, number of events attended, number of exercise activities in which the athletic equipment was used, intensity of activities attended, or any suitable combination thereof (e.g., as indicated by formulae or logical statement) over the lifetime of the athletic equipment. A replacement threshold for a wear metric may vary depending on the type of the athletic equipment. For example, a sprinting shoe may be expected to wear out after fewer miles than a distance running shoe.

Each athletic equipment may be described in an equipment profile using a variety of usage metrics. Athletic equipment may then be selected for replacement if it is older than a predefined age, or has received more than a threshold amount of wear. For example, the distance shoes in equipment profile 900 are described as needing replacement when any of the following wear metrics is met: seven hundred and fifty kilometers traveled, nine hundred thousand steps taken, fifty kilometers of elevation change traveled. The shoes are also subject to age-based replacement after one year of age. However, age-based replacement is not considered to be a metric of wear.

In a similar fashion to the distance shoes in equipment profile 900, the road bicycle in equipment profile 1000 includes a variety of lifetime metrics, including wear metrics such as distance traveled, and amount of elevation change. Another lifetime metric for the road bicycle is a period of time that the road bicycle has been owned or used. However, this is not considered a wear metric. The equipment profile 1000 shows that the road bicycle itself includes components that have their own wear lifetimes, such as cog sets (e.g., gear sets), tires, and brakes. Each of the components may be tracked in its own profile, allowing for wear metrics to be tracked on an individualized basis for these components. For example, FIG. 11 depicts an equipment profile for road tires that are currently on the road bicycle of equipment profile 1000.

By reviewing the various user profiles, activity records, and equipment profiles discussed above, a controller 112 of the tracking server 110 may engage in a process of replacing athletic equipment on an as-needed basis, by dynamically determining amounts of wear applied during exercise activities.

While no specific file format is provided for the records and profiles discussed herein, they may be stored as entries in a database, may be stored as Extensible Language Markup (XML) data, may be stored in a proprietary file format, etc.

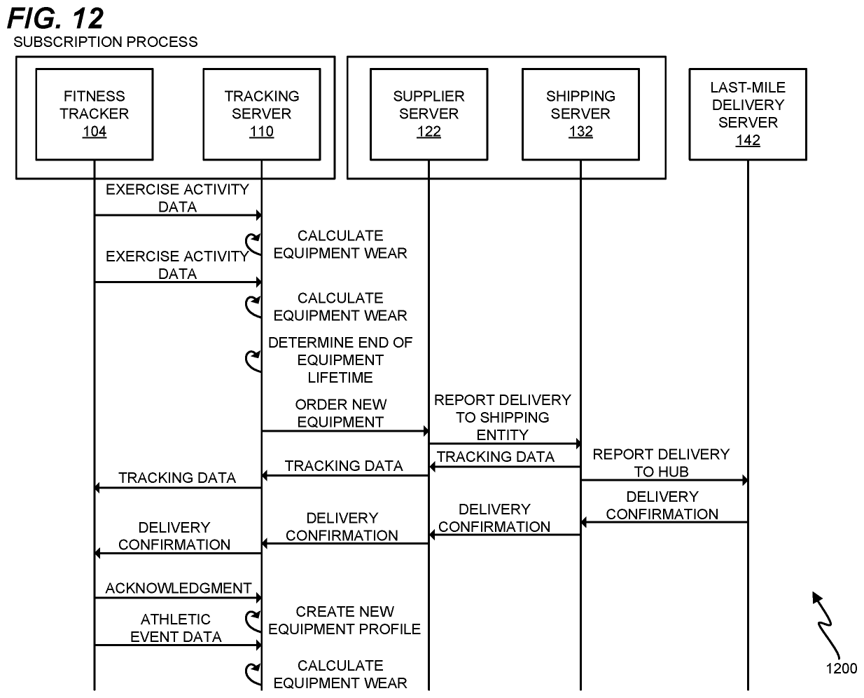

FIG. 12 is a message diagram 1200 depicting communications between components of a delivery architecture in order to provide dynamic wear-based replacement of athletic equipment in an illustrative embodiment. Assume, for this embodiment, that a user has updated their profile to include billing information, a delivery address, and a list of owned athletic equipment.

As shown in FIG. 12, a fitness tracker 104 transmits messaging (e.g., raw measurements, determined metrics, and/or exercise activity records) that indicates exercise activity performed by a user to a tracking server 110. A controller 112 at the tracking server 110 analyzes this messaging to determine amounts of wear applied to athletic equipment of users during exercise activities. New messaging is received by the fitness tracker 104 over time until tracking server 110 determines that athletic equipment owned or operated by the athlete 102 has reached the end of its lifetime (or is about to reach the end of its lifetime within the next week, month, other period of time, etc.). Upon determining that the athletic equipment is ready for replacement, the tracking server 110 transmits messaging to a supplier server 122 to place an order for replacement athletic equipment for the athlete. The supplier server 122 coordinates with a shipping server 132 of a shipping entity to arrange for delivery of the replacement athletic equipment, and transmits a confirmation when the replacement athletic equipment has been delivered to the shipping entity. The confirmation may also or alternatively be transmitted to the athlete via a fitness tracker 104, a computer, or to tracking server 110. Upon the replacement athletic equipment reaching a shipping entity, the shipping server 132 provides tracking data to supplier server 122, tracking server 110, and/or fitness tracker 104 for review. The shipping server 132 awaits confirmation that the replacement athletic equipment has been delivered to a delivery hub, and then transmits messaging reporting that delivery to last-mile delivery server 142. The last-mile delivery server 142 awaits delivery to an address for the athlete 102, and then reports the delivery via fitness tracker 104, tracking server 110, supplier server 122, and/or shipping server 132. The last-mile delivery server 142 also provides a confirmation that the delivery has been completed.

Upon completion of the delivery, a user 106 optionally provides an acknowledgment via the fitness tracker 104 or a computer to indicate that the replacement piece of athletic equipment was received. Additionally, or alternatively, the last mile delivery server 142, shipping server 132, and/or supplier server 122 may provide such a confirmation, and tracking server 110 may provide a notification to the user 106 based on the confirmation. The tracking server 110 updates profile data for the athlete 102 to remove the old equipment and add the replacement equipment. Then, the tracking server 110 awaits new messaging describing additional exercise activities performed by the athlete 102 with the replacement athletic equipment, in order to update amounts of wear applied to the replacement athletic equipment.

In further embodiments, controller 112 may provide additional and/or more advanced types of athletic goods, based on a number of athletic goods worn out or consumed by an athlete 102. For example, if an athlete 102 has worn out more than a threshold number of pairs of beginner-level shoes, then controller 112 may provide a pair of intermediate-level shoes to replace the beginner-level. In further embodiments, controller 112 may consider other indicators that an athlete has transformed or advanced in expertise. These indicators may include, for example, completion of an exercise activity such as a run or bicycle ride in less than a threshold amount of time, completion of a number of reps at a threshold amount of weight, etc.

While the processes discussed above are provided with reference to a singular instance of athletic equipment, in practice these methods are utilized on an ongoing basis for athletic equipment operated by countless thousands or millions of athletes 102. Hence, the complexity of these operations in a real-world environment is daunting and non-trivial, and cannot be performed by hand or as a mental process.

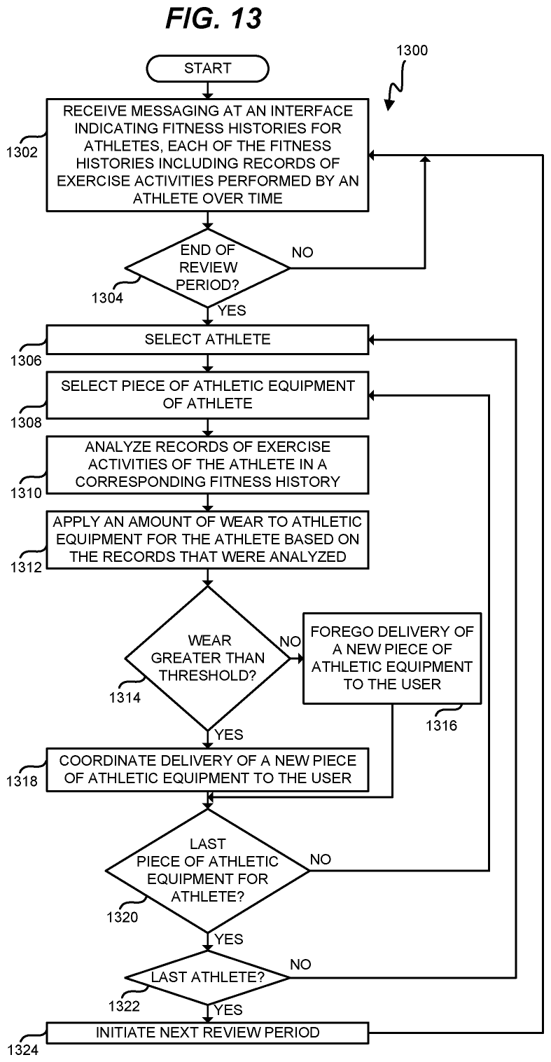

Illustrative details of the operation of delivery network 100 will be discussed with regard to FIG. 13. Assume, for this embodiment, that a population of thousands or millions of athletes 102 have each been associated with a user account and registered for a wear-based subscription service, and that tracking server 110 stores a profile 115 for each athlete 102. Each profile 115 indicates the name and type of each athletic equipment owned or operated by a corresponding athlete.

FIG. 13 is a flowchart illustrating a method 1300 for providing activity-based subscriptions in an illustrative embodiment. The steps of method 1300 are described with reference to delivery network 100 of FIG. 1, but those skilled in the art will appreciate that method 1300 may be performed in other systems. The steps of the flowcharts described herein are not all inclusive and may include other steps not shown. The steps described herein may also be performed in an alternative order.

Step 1302 of method 1300 includes receiving messaging at interface 113 of tracking server 110 indicating fitness histories 116 for athletes 102. The fitness history 116 for each athlete includes records of exercise activities performed by an athlete 102 over time. The messaging may be received in ICAL, JSON, HTTP, SMS, or other electronic formats, and may comprise information for inclusion in a fitness history. This information may include raw measurements describing an exercise activity (or state of the user during the exercise activity), processed statistics that have been determined based on raw measurements, indications that the user has registered for or participated in a group event, such as a race, or other information. In one embodiment, the messaging is converted by normalization server 320 into a uniform format for interpretation by the tracking server 110. In one embodiment, the uniform format matches the structure for activity records provided in FIGS. 7-8.

The messaging acquired during step 1302 may be acquired on a periodic, ongoing, or real-time basis, according to push notifications or pull notifications, or any combination thereof. Furthermore, the messaging is provided for the population of athletes 102 over time, and hence controller 112 of the tracking server 110 engages in actively categorizing incoming messaging based on the athlete 102 that the messaging pertains to.

Step 1304 includes determining whether or not the end of a review period has been reached. A review period may comprise an hour, a day, a week, a month, or other unit of time. Furthermore, the review period for different athletes may be of the same or different duration, and may end at the same or different time as the review period for other athletes in the population. If the end of the review period has not been reached at step 1304, then the tracking server 110 proceeds to step 1302, and continues to acquire new messaging and update the fitness histories 116 for each athlete 102.

If the end of the review period has been reached at step 1304, then controller 112 of the tracking server 110 engages in a process of determining whether athletic equipment for one or more athletes of the population (e.g., just one athlete, the entire population, or some fraction thereof) is in need of replacement. Controller 112 therefore advances to step 1306 for selecting an athlete.

Selecting an athlete 102 comprises identifying a profile 115 for an athlete and loading the profile 115. The controller 112 then analyzes the profile 115 in step 1308 by selecting athletic equipment owned or operated by the athlete 102. This may comprise reviewing the profile 115 to identify equipment profiles, and/or identifiers or links for equipment profiles.

In step 1310, the controller 112 analyzes records of exercise activities of the athlete 102 in a corresponding fitness history 116. This comprises reviewing the exercise activities to determine amounts of wear that are applicable to the current equipment owned or operated by the athlete 102. Types of wear, and activities that apply wear, are determined based on the type of the athletic equipment being reviewed.

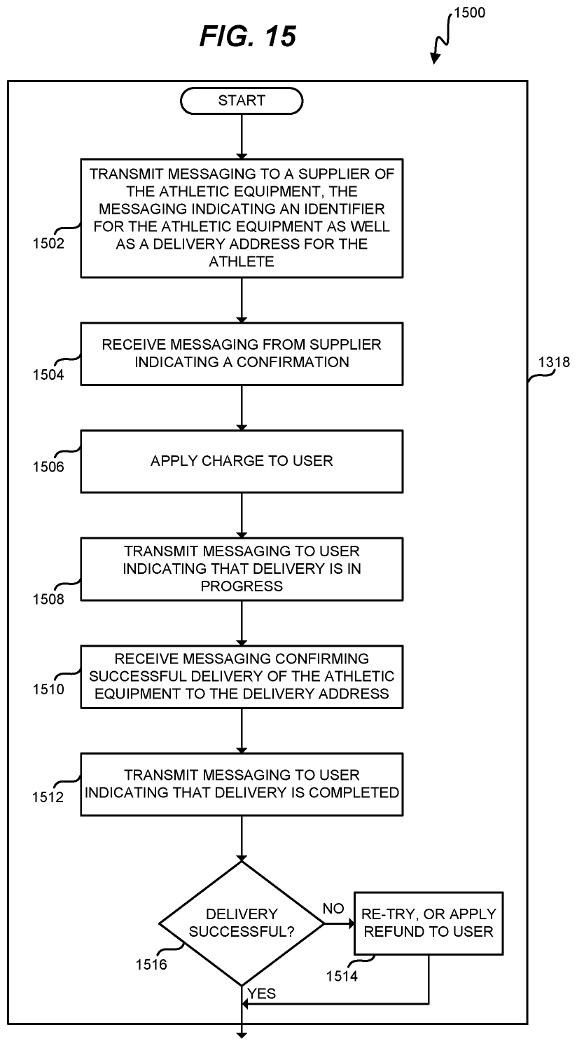

In step 1312, the controller 112 applies an amount of wear to athletic equipment for the athlete based on the records that were analyzed. This may be performed by detecting a wear metric for the athletic equipment (e.g., total steps during exercise activities, total distance traveled during exercise activities, etc.), and determining that the record describes an increase in the wear metric (e.g., three thousand steps taken, two miles traveled). In one embodiment, each type of athletic equipment is tagged/associated with one or more categories of exercise activities. For example, the type “bicycles” may be tagged with a “cycling” category, while the type “weights” may be tagged with a category for “lifting,” for “cross-fit” and other categories. If a record for an exercise activity indicates that the activity is in a category assigned to a type of athletic equipment owned or operated by the athlete 102, then the controller 112 may apply any wear indicated in the record for the exercise activity to the profile for the athletic equipment, thereby increasing the amount of wear. Analyzing the fitness history 116 of the user to determine an amount of wear for athletic equipment is further described in detail with respect to method 1500 of FIG. 15.

After applying the amount of wear to the athletic equipment by exercise activities in the review period, the controller 112 advances to step 1314. Step 1314 includes determining whether wear for the athletic equipment (e.g., across the lifetime of the athletic equipment) is greater than a threshold amount (e.g., ninety percent of a lifetime value for the piece of athletic equipment, another percentage, an amount indicating that the athletic equipment will exceed its lifetime value before the next review period, next day, next week, or next month, etc.). If the wear is not greater than the threshold, then processing proceeds to step 1316 of foregoing delivery of new athletic equipment to the user. Alternatively, if the wear is greater than or equal to the threshold, then the controller 112 performs step 1318 of coordinating delivery of new athletic equipment to the athlete 102. In one embodiment, the threshold comprises a formula or weighted combination of different wear metrics. For example, a threshold may be reached if three hundred miles are traveled, fifty miles of vertical elevation change occurs, or if some suitable weighted combination of those wear metrics is reached (e.g., if eighty percent of the distance lifetime and eighty percent of the vertical elevation change are reached)

Step 1318 of coordinating delivery of new athletic equipment to the athlete is described in detail with respect to method 1500 of FIG. 15. However, this process includes exchanging messaging with a supplier in order to purchase and/or arrange for delivery of the new athletic equipment. In one embodiment, controller 112 selects the new equipment as a same model of the prior equipment being replaced. In another embodiment, the new equipment is a different model, make, or brand than the current one, based on either a predefined subscription plan, a promotion, a preference of the athlete or user, or an analysis of feedback from the athlete indicating that the prior athletic equipment is not optimal (e.g., input indicating that the prior athletic equipment was not liked by the athlete, was not comfortable for the athlete, etc.). After initial order placement for the new athletic equipment, coordinating may continue in parallel with other processes discussed in this method for other equipment.

Processing continues to step 1318 of determining whether the profile for a last athletic equipment (e.g., profiles for all athletic equipment) for the athlete have been updated based on the fitness history. If not, processing returns to step 1308. If so, processing advances to step 1320 for determining whether athletic equipment for the last athlete has been analyzed for the review period. If the athletic equipment of the last athlete has not yet been reviewed, then processing returns to selecting 1306 a new athlete. Otherwise, the method 1300 includes initiating 1322 a next review period. Any of the steps described herein may be performed in serial or in parallel for different athletic events, fitness histories, athletic equipment, and/or athletes.

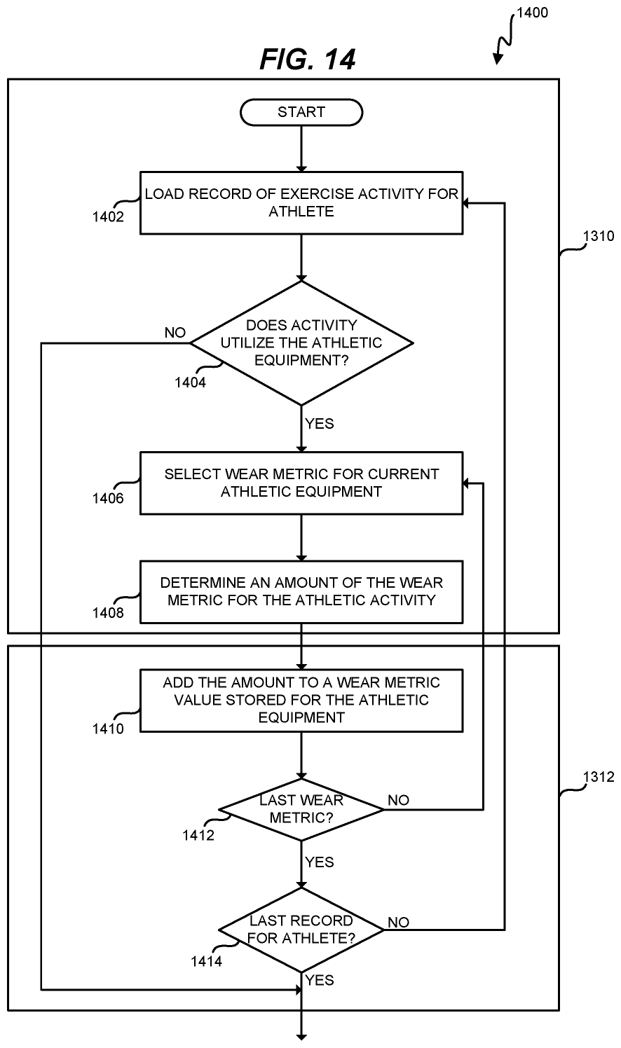

FIG. 14 is a flowchart illustrating additional details of the method of FIG. 13 in an illustrative embodiment. Specifically, FIG. 14 depicts further details of step 1310 and step 1312. According to method 1400, step 1402 includes loading a record of an exercise activity for an athlete 102. In one embodiment, this comprises loading the record from a fitness history 116 stored in memory for a specific athlete.

Step 1404 comprises determining whether the exercise activity utilizes specific athletic equipment for the athlete. In one embodiment, this comprises comparing a category defined for the activity (e.g., indicating a sport for the activity, indicating a group performing or hosting the activity, indicating a type of exercise performed during the activity, etc.) to an exercise associated with a type defined for the athletic equipment. As discussed above, athletic equipment may be assigned a type indicating what the athletic equipment does or what the athletic equipment is. For example, athletic equipment may be assigned to one or more types of varying breadth, such as “aerobics exercise device,” “bicycle,” “road bicycle,” etc. Each type may be associated with one or more exercises. For example, a road bicycle may be associated with exercises of “cycling,” “velodrome,” “road cycling,” and others.

If one of the categories for the activity matches an exercise for the athletic equipment, and the athletic equipment is the only matching athletic equipment for the athlete in its type, then the controller 112 determines that the athletic equipment was utilized during the exercise activity. For example, if the type of the athletic equipment is shoes, categorized for “distance running,” and these are the only shoes that are categorized for distance running by the athlete 102, then they can be reliably determined to be the shoes used during an exercise activity categorized for distance running.

Alternatively, if multiple instances of athletic equipment of the same type match the category of the athletic event, then controller 112 may determine whether one athletic equipment is listed as default equipment, and select that athletic equipment. In a further embodiment, controller 112 identifies athletic equipment specifically indicated in the exercise activity, or analyzes specific types for athletic equipment of the same general type. For example, if an exercise activity is listed as a “bicycle ride,” but speed and/or location data indicates that this ride was on a road (as indicated by high speeds followed by stopping), then if two instances of athletic equipment are owned by the athlete such as a road bicycle and a trail bicycle, the road bicycle may be preferentially selected, even though either bicycle can technically be used for a ride. The road bicycle best matches the circumstances of the ride in question.

If the exercise activity does not utilize the athletic equipment in step 1404, then processing returns to step 1402 where a next exercise activity is loaded. Alternatively, if the athletic does utilize the athletic equipment in step 1404, then processing continues to step 1406.

In step 1406, a wear metric is selected for the athletic equipment. For each of the wear metrics, the controller 112 determines an amount of wear indicated by the record for the exercise activity in step 1408, and then adds the amount to a wear metric value stored for the athletic equipment. For example, if a pair of shoes has a wear metric for distance traveled that is currently six kilometers, and an exercise activity indicates five kilometers of travel, the wear metric stored in the equipment profile for the shoes is updated to indicated eleven kilometers of travel.

In one embodiment, the amount of wear is modified by a multiplier based on an intensity of the exercise activity, or a condition during the exercise activity. For example, exercise activities performed during inclement weather (e.g., rain storms, heat waves, etc.), on rough terrain (e.g., lava fields or scree), and/or at different than an average level of intensity (e.g. high intensity workouts) or speed, may be multiplied by an amount greater than one to indicate the increased level of wear (e.g., a multiplier greater than one and less than ten). Similarly, other conditions, such as performance of an activity at a lower intensity level, may be modified by a multiplier of less than one (e.g., between 0.9 and 0.1). The conditions in which an activity was performed may be listed in the record for that exercise activity. The specific multiplier for each condition may vary depending on the type of athletic equipment. For example, swimming in the rain is not expected to increase wear applied to a set of flippers, while running in the rain may increase wear on distance running shoes. Based on rules or a table stored in memory 114, controller 112 may determine the multiplier for each of these conditions for each type of athletic equipment.

If the last wear metric has not yet been applied in step 1412, then a new wear metric for the athletic equipment is selected in step 1406. For example, a pair of shoes may first be updated to apply additional distance, and then later be updated based on the same event to apply additional amounts of elevation change. If any of the wear metrics reaches a lifetime value, then the equipment may need to be replaced.

If the last wear metric has been applied in step 1412, then in step 1414 a determination is made whether the record is the last record (e.g., most recent record, or final record for the review period) in the fitness history. If so, processing moves on to step 1312. If not, a next record for a next exercise activity is loaded in step 1402.

In further embodiments, athletic equipment may also be selected for replacement if it exceeds a time-of-ownership threshold, controller 112 may engage in the replacement processes discussed herein.

FIG. 15 is a flowchart illustrating additional details of the method of FIG. 13 in an illustrative embodiment. Method 1500 specifically describes an illustrative embodiment of step 1316, wherein tracking server 110 coordinates delivery of new athletic equipment to an athlete 102. First, the controller 112 determines a type of the equipment, and determines whether or not to replace the type of equipment with the same make, model, and/or brand of equipment. In one embodiment, an athlete provides a rating of their piece of athletic equipment indicated in a profile for that piece of athletic equipment. If the rating is below a threshold value (e.g., three out of five stars, “good”), then the controller 112 selects a new make, model, or brand of the same type as the prior equipment. Alternatively, the controller 112 may select a make, model, or brand of athletic equipment based on existing partnerships or promotions with third parties, based on a schedule that explicitly lists this information, or based on other criteria.

In step 1502, controller 112 operates interface 113 to transmit messaging to a supplier of the athletic equipment. The messaging indicates an identifier for the athletic equipment (e.g., a model number or serial number), as well as a delivery address for the athlete 102. The delivery address may comprise a home address or business address of the athlete, or a location at which an event will take place that the athlete is attending. In one embodiment, the controller analyzes a profile 115 for the athlete 102 to determine the delivery address.

The controller 112 may transmit the messaging by operating the interface to provide content to an Application Programming Interface (API) for the supplier in accordance with a predefined data format, may send an email to the supplier, or may perform any other suitable action to indicate placement of an order for a replacement piece of athletic equipment. In a further embodiment, the controller 112 transmits messaging to multiple suppliers that includes a bid price. The first supplier willing to meet the bid price is chosen for providing the new piece of equipment.

In step 1504, the controller receives messaging indicating a confirmation from the supplier. The confirmation may include a model number or serial number for the athletic equipment, an expected delivery date, and/or other information.

Based on the confirmation, in step 1506 the controller 112 applies a charge to the user. In one embodiment, this is performed based on billing information (e.g., credit card information) stored for the user or athlete at the tracking server 110). The controller 112 further operates the interface 113 to transmit messaging to the user 106 and/or athlete 102 indicating that delivery is in progress in step 1508. If an anticipated delivery date was received in the confirmation, then the controller 112 may provide this information, in addition to details describing the replacement piece of athletic equipment.

In step 1510, the controller 112 receives messaging via interface 113 (e.g., from the supplier, a shipment entity, or a last-mile delivery entity) that the replacement piece of athletic equipment has been delivered to the delivery address for the athlete 102. The controller 112 therefore generates and transmits a message for the user and/or athlete indicating that delivery is completed in step 1512, and operates interface 113 to provide the message via SMS, email, an application on a phone, a web portal, or via other means.

If the controller 112 receives an indication from the user 106 that the delivery was not successfully completed in step 1516, controller 112 may proceed to attempt to re-try the delivery, or to apply a refund to the user in step 1514.

Methods 1300-1500 provide a technical benefit to the field of delivery by enabling just-in-time delivery of athletic equipment and goods on a massive scale based on the actual activity of athletes, instead of based purely on the passage of time. This enhances fitness training by reducing the number of instances where athletes work out on “dead” or overworn equipment, and also reduces waste by preventing the delivery of athletic equipment to athletes whose equipment has not yet reached the end of its lifetime.

### EXAMPLES

In the following examples, additional processes, systems, and methods are described in the context of a network architecture for facilitating activity-based subscriptions.

In this example, an athlete engages in triathlons. A coach for the triathlete registers an account for the athlete at a tracking server 110 via a website, and operates the account to create activity-based subscriptions for the triathlete. The coach subscribes the triathlete to activity-based replacement of distance running shoes, as well as activity-based replacement of bicycle components. The coach also submits billing information and a delivery address for the triathlete, and indicates a bicycle owned by the triathlete, and a pair of running shoes owned by the triathlete. The tracking server utilizes the provided information to generate a profile for the triathlete, and to generate equipment profiles for the bicycle and the shoes, respectively.

The athlete wears a fitness tracker in the form of a smart watch that automatically detects and records exercise performed by the athlete, and utilizes accelerometer data and GPS data to distinguish swimming, running, and cycling activities of the triathlete. The fitness tracker reports these raw measurements of accelerometer and GPS data to a cellular phone that is paired with the fitness tracker. The cellular phone utilizes an app to analyze the raw measurements to create processed statistics describing speed, cadence (i.e., pedaling rate), and pedometry via known techniques. The cellular phone determines the start and end of exercise activities based on accelerometer data indicating that running, swimming, or cycling has ceased. The cellular phone compiles information for exercise activities into records on an activity-by-activity basis, and transmits new records to tracking server 110 as the records are created. Upon receiving a record, the tracking server 110 determines an athlete associated with the record, and updates a fitness history for the triathlete to include the new record. The triathlete is one of hundreds of thousands of athletes whose data is tracked and updated in this manner.

At the end of each day, the tracking server 110 proceeds through the records received for each athlete, and updates equipment profiles for each athlete to determine amounts of accumulated wear for athletic equipment. For the triathlete described above, the analysis determines that exercise activities which are categorized for swimming do not impact wear on the bicycle or running shoes. However, the running shoes receive wear based on reported runs performed by the triathlete, and components of the bicycle receive wear based on reported rides performed by the triathlete. The shoes are associated with wear metrics for distance, elevation gain, and steps taken. The equipment profile for the shoes is updated based on the record for each run. For example, a record may indicate that two thousand steps were taken, resulting in an update to that wear metric in the equipment profile. For the components of the bicycle, each component has its own equipment profile. Certain components, such as cog sets and tires, are replaced via wear metrics for mileage and/or elevation change during exercise activities. Other components, such as brakes, are replaced based on wear metrics for mileage, and metrics indicating a number of emergency braking maneuvers performed (based on accelerometer data).

When a wear metric indicates that the cog set has reached ninety percent of its expected usable lifetime, the tracking server 110 transmits messaging ordering a new cog set from a supplier. A server of the supplier receives the messaging, and coordinates delivery of a new cog set to the user. The supplier then charges an operator of the tracking server 110, and the tracking server provides a bill to the coach that covers the cost of the cog set, a delivery fee, and an additional fee for the subscription services.

The supplier coordinates with a delivery service to provide the new cog set, and upon replacement of the cog set, the coach operates a computer to transmit a message that the new cog set is installed on the bicycle. The tracking server 110 receives this information, deprecates the equipment profile for the old cog set, generates a new equipment profile for the new cog set, and updates the equipment profile for the bicycle to indicate that the new cog set is a component of the bicycle. Similar operations are performed for the brakes, tires, and shifters of the bicycle. The triathlete also subscribes to a supplemental nutrition plan via the tracking server 110, and the tracking server delivers nutritional supplies to the triathlete based on estimated calories burned during exercise activities. The estimate is based on the speed, distance, and duration of each exercise activity, as well as the category of exercise activity performed. For example, the tracking server may compare speed, distance, and duration data to a table stored in memory for each category of exercise activity, in order to estimate calories burned.

Any of the various control elements (e.g., electrical or electronic components) shown in the figures or described herein may be implemented as hardware, a processor implementing software, a processor implementing firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, a control element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

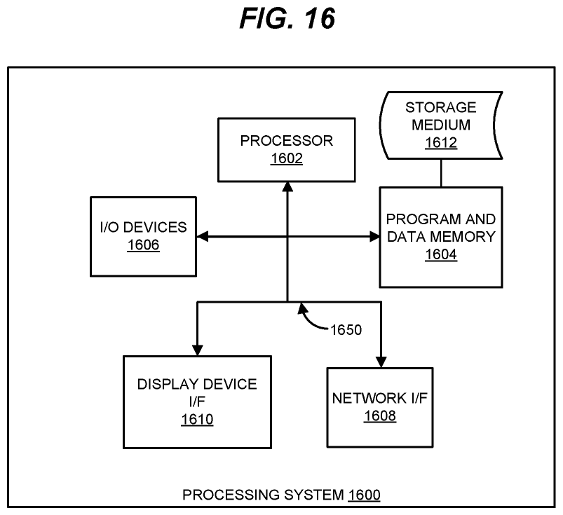

In one particular embodiment, instructions stored on a computer readable medium are used to direct a computing system of fitness tracker 104, tracking server 110, and/or other devices to perform the various operations disclosed herein. FIG. 16 illustrates an illustrative computing system 1600 operable to execute a computer readable medium embodying programmed instructions. Computing system 1600 is operable to perform the above operations by executing programmed instructions tangibly embodied on computer readable storage medium 1612. In this regard, embodiments of the invention can take the form of instructions (e.g., code) accessible via computer-readable medium 1612 for use by computing system 1600 or any other instruction execution system. For the purposes of this description, computer readable storage medium 1612 comprises any physical media that is capable of storing the program for use by computing system 1600. For example, computer-readable storage medium 1612 may be an electronic, magnetic, optical, electromagnetic, infrared, semiconductor device, or other non-transitory medium. Examples of computer-readable storage medium 1612 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Computing system 1600, which stores and/or executes the instructions, includes at least one processor 1602 coupled to program and data memory 1604 through a system bus 1650. Program and data memory 1604 include local memory employed during actual execution of the program code, bulk storage, and/or cache memories that provide temporary storage of at least some program code and/or data in order to reduce the number of times the code and/or data are retrieved from bulk storage (e.g., a spinning disk hard drive) during execution.

Input/output or I/O devices 1606 (including but not limited to keyboards, displays, pointing devices, etc.) may be coupled either directly or through intervening I/O controllers. Network adapter interfaces 1608 may also be integrated with the system to enable computing system 1600 to become coupled to other data computing systems or storage devices through intervening private or public networks. Network adapter interfaces 1608 may be implemented as modems, cable modems, Small Computer System Interface (SCSI) devices, Fibre Channel devices, Ethernet cards, wireless adapters, etc. Display device interface 1610 may be integrated with the system to interface to one or more display devices, such as screens for presentation of data generated by processor 1602.

Although specific embodiments are described herein, the scope of the disclosure is not limited to those specific embodiments. The scope of the disclosure is defined by the following claims and any equivalents thereof.

What is claimed is:

1. A system comprising:
a tracking server comprising:
an interface that receives messaging indicating fitness histories for athletes, each of the fitness histories including records that indicate exercise activities performed by an athlete over time; and
a controller that, for each of the athletes, analyzes records of exercise activities of the athlete in a corresponding fitness history, applies an amount of wear to athletic equipment for the athlete based on the records that were analyzed, and determines whether the athletic equipment exceeds a threshold level of wear;
in the event that the athletic equipment exceeds the threshold level, the controller coordinates delivery of new athletic equipment to the athlete, and
in the event that the athletic equipment does not exceed the threshold level, the controller foregoes delivery of the new athletic equipment to the athlete.

2. The system of claim 1 wherein:
the athletic equipment comprises shoes, and the controller determines the amount of wear based on at least one metric selected from the group consisting of: a distance traveled during the exercise activities, and a number of steps taken during the exercise activities.

3. The system of claim 1 wherein:
the athletic equipment comprises bicycle tires, and the controller determines the amount of wear based on at least one metric selected from the group consisting of: a distance traveled during the exercise activities, and an amount of elevation change during the exercise activities.

4. The system of claim 1 wherein:
the controller coordinates delivery by:
transmitting messaging via the interface to a supplier of the athletic equipment, the messaging indicating an identifier for the athletic equipment as well as a delivery address for the athlete,
detecting messaging via the interface confirming successful delivery of the new athletic equipment to the athlete.

5. The system of claim 1 wherein:
the exercise activities include at least one piece of information selected from the group consisting of: scheduled events listed on a calendar, a workout history, reported event attendance for the athlete, a dietary log of the athlete, and a wellness log of the athlete.

6. The system of claim 1 wherein:
the fitness histories include exercise activities dynamically determined by wearable devices of the athletes.

7. The system of claim 1 wherein:
the fitness histories include exercise activities dynamically determined by mobile devices of the athletes.

8. The system of claim 1 wherein:
the exercise activities include at least one piece of raw data selected from the group consisting of: sleep tracking data, step tracking data, heart rate data, elevation data, accelerometer data, pulse data, and audio data.

9. A method comprising:
receiving messaging at an interface indicating fitness histories for athletes, each of the fitness histories including records that indicate exercise activities performed by an athlete over time; and
for each of the users:
analyzing records of exercise activities of the athlete in a corresponding fitness history;
applying an amount of wear to athletic equipment for the athlete based on the records that were analyzed;
determining whether the athletic equipment exceeds a threshold level of wear;
in the event that the athletic equipment exceeds the threshold level, coordinating delivery of new athletic equipment to the athlete; and
in the event that the athletic equipment does not exceed the threshold level, foregoing delivery of the new athletic equipment to the athlete.

10. The method of claim 9 wherein:
the athletic equipment comprises shoes, and determining the amount of wear is based on at least one metric selected from the group consisting of: a distance traveled during the exercise activities, and a number of steps taken during the exercise activities.

11. The method of claim 9 wherein:
the athletic equipment comprises bicycle tires, and determining the amount of wear is based on at least one metric selected from the group consisting of: a distance traveled during the exercise activities, and an amount of elevation change during the exercise activities.

12. The method of claim 9 wherein:
coordinating delivery comprises:
transmitting messaging via the interface to a supplier of the athletic equipment, the messaging indicating an identifier for the athletic equipment as well as a delivery address of the athlete, and
detecting messaging via the interface confirming successful delivery of the athletic equipment to the athlete.

13. The method of claim 9 wherein:
the exercise activities include at least one piece of information selected from the group consisting of: scheduled events listed on a calendar, a workout history reported in a training regime, reported event attendance for the athlete, a dietary log of the athlete, and a wellness log of the athlete.

14. The method of claim 9 wherein:
the fitness histories include exercise activities dynamically determined by wearable devices of the athletes.

15. The method of claim 9 wherein:
the fitness histories include exercise activities dynamically determined by mobile devices of the athletes.

16. The method of claim 9 wherein:
the exercise activities include raw data selected from the group consisting of sleep tracking data, step tracking data, heart rate data, elevation data, accelerometer data, pulse data, and audio data.

17. A non-transitory computer readable medium embodying programmed instructions which, when executed by a processor, are operable for performing a method comprising:
receiving messaging at an interface indicating fitness histories for athletes, each of the fitness histories including records that indicate exercise activities performed by an athlete over time;
for each of the users:
analyzing records of exercise activities of the athlete in a corresponding fitness history;
applying an amount of wear to athletic equipment for the athlete based on the records that were analyzed;
determining whether the athletic equipment exceeds a threshold level of wear;
in the event that the athletic equipment exceeds the threshold level, coordinating delivery of new athletic equipment to the athlete; and
in the event that the athletic equipment does not exceed the threshold level, foregoing delivery of the new athletic equipment to the athlete.

18. The non-transitory computer readable medium of claim 17 wherein:
the athletic equipment comprises shoes, and determining the amount of wear is based on at least one metric selected from the group consisting of: a distance traveled during the exercise activities, and a number of steps taken during the exercise activities.

19. The non-transitory computer readable medium of claim 17 wherein:
the athletic equipment comprises bicycle tires, and determining the amount of wear is based on at least one metric selected from the group consisting of: a distance traveled during the exercise activities, and an amount of elevation change during the exercise activities.

20. The non-transitory computer readable medium of claim 17 wherein:
coordinating delivery comprises:
transmitting messaging via the interface to a supplier of the athletic equipment, the messaging indicating an identifier for the athletic equipment as well as a delivery address of the athlete, and
detecting messaging via the interface confirming successful delivery of the athletic equipment to the athlete.
